(19) United States
(12) Patent Application Publication
(10) Pub. No.: US 2005/0022225 A1
(43) Pub. Date: Jan. 27, 2005

(54) Optically readable carrier

(76) Inventor: Mark Anthony Blackford, Waddon (GB)

Correspondence Address: JEAN M. MACHELEDT, 501 SKYSAIL LANE, SUITE B100, FORT COLLINS, CO, 80525-3133, US

(21) Appl. No.: 10/491,693

(22) PCT Filed: Oct. 2, 2002
(86) PCT No.: PCT/GB02/04449

(30) Foreign Application Priority Data
Oct. 2, 2001 (GB) 0123667.8

(51) Int. Cl. G11B 11/00

(52) U.S. Cl. 720/718; 720/721

(57) ABSTRACT

A double-sided disc for use in two different types of optical readers, the disc comprising a first side which is readable by a first type of optical reader and a second side which is readable by a second type of optical reader. The disc is preferably suitable for use in a CD player and a DVD player. A removable hub may be positioned to provide either a CD mode or a DVD mode.

This invention relates to an optically readable carrier which is suitable for use in two different types of optical readers, for example, in a CD (compact disc) player and a DVD (digital versatile disc) player.

The background technology for CDs and DVDs is well-known. CDs generally comprise a reflective (silvered) layer containing digital information which is read by a laser. CDs are sold in their millions worldwide and are currently the preferred format for listening to music in the home.

DVDs were developed more recently than CDs. The advantage of DVDs is that they are capable of storing much more information than CDs. DVDs generally comprise a reflective (silvered) layer and one or more partially reflective or semi-transparent layers. In operation, a laser reads information from each of the partially reflective layers and the reflective (silvered) layer. Furthermore, in DVDs the spacing between adjacent tracks is about half that of the spacing in CDs.

The combination of a plurality of readable layers, finer track spacing and pit layers means that DVDs are capable of storing more information than CDs. Accordingly, DVDs are being used increasingly for viewing films and the like in the home. It is expected that DVDs will replace home videos in the same way that CDs have, to a large extent, replaced vinyl records and magnetic cassette tapes. There is an increasingly high demand for DVDs throughout the world.

At present, it is not possible to play a DVD in a standard CD player. This is because standard CD players use lasers having a different focussing distance and a different wavelength compared to DVD players. If, for example, one bought a DVD of a film and wished to listen to the soundtrack in a car CD player, then it would be necessary to buy a CD of the film soundtrack. It is not possible to play the DVD in, for example, a standard car CD player. By a standard CD player, it is meant a CD player which has not been specially designed or adapted for playing DVDs.

The requirement of buying both a CD and a DVD in order to enjoy a product fully is obviously undesirable. Consumers are less likely to be willing to pay extra money for a CD in addition to a DVD which they may already own.

Moreover, it is believed that the superior format of DVDs will eventually replace the well-established CD format. However, consumers who presently buy CDs are not likely to buy DVDs if they do not have the means for playing DVDs. Nevertheless, consumers may be aware that their CDs could be outdated technology in a few year's time. Consumers might therefore consider delaying their purchase of CDs until such time that they have means for playing DVDs. This would avoid purchasing the same product twice in different formats. From a marketing point of view, this situation is undesirable.

With the foregoing in mind, it is an object of the present invention to provide a disc which can be played in both DVD players and existing CD players.

Accordingly, the present invention provides a double-sided disc suitable for use in two different types of optical readers, said disc comprising a first side which is readable by a first type of optical reader and a second side which is readable by a second type of optical reader.

Preferably, the present invention provides a double-sided disc suitable for use in a CD player and a DVD player, said disc comprising a first CD-readable side and a second DVD-readable side.

Hitherto, double-sided discs having a CD-readable side and a DVD-readable side have not been proposed, even though the two technologies are well-known. This is because the lasers in DVD players and CD players have different focussing distances and finer resolutions, as will be explained below.

In DVD players, in order that the laser is properly focused, there is an optimum distance between the laser and the reflective DVD-readable layer(s) in the DVD. This optimum distance is usually achieved when the silvered reflective DVD-readable layer is 0.6 mm from the outer surface of the disc facing the laser or when a partially reflective DVD-readable layer is 0.3 mm from the outer surface of the disc facing the laser. The partially reflective DVD-readable layer is read in a similar fashion with the laser being refocused.

Likewise, in CD players there is an optimum distance between the laser and the reflective CD-readable layer in the CD. This optimum distance is usually achieved when the reflective CD-readable layer is 1.2 mm from the outer surface of the disc facing the laser.

Thus, the optimum distance between the laser and the CD-readable layer in a CD player is longer than the corresponding distance in a DVD player. In order to provide a double-sided disc which is suitable for use in a CD player and a DVD player, it needs to be ensured that the reflective DVD- and CD-readable layers are both at a suitable distance from the relevant laser when in use.

A further consideration is the overall thickness of the disc. Thus, it is not possible to simply bond a conventional CD to a conventional DVD and get acceptable results. CD- and DVD-players are designed to accommodate discs having a thickness of about 1.2 mm. A standard CD bonded to a standard DVD would necessarily be about 1.8 mm thick. Any significant variation from a thickness of 1.2 mm would normally result in instability of the rotating disc. Moreover, the drive spindle in standard CD players is designed to receive discs which are 1.2 mm thick.

The present invention addresses the problem of providing the optimum focussing distances in both a CD player and a DVD player.

Preferably, the disc of the present invention is adapted to receive a removable hub which can be positioned to provide either a CD mode or a DVD mode. The hub may be removable from a central non-readable part of the disc. The surface design of each side of the non-readable part of the disc determines the extent to which the hub protrudes from the disc. Hence, in operation, when the hub rests on a spindle, the laser focussing distance and the mode of operation are ultimately governed by the surface design of each side of the non-readable part of the disc.

For example, there may be a recessed portion which receives the hub on one side of the disc. This will provide a short laser focussing distance. Alternatively, there may be a non-recessed portion on one side of the disc. This will provide an intermediate focussing distance. Alternatively, there may be a raised portion on one side of the disc. This will provide a long laser focussing distance. Thus, the double-sided discs of the present invention provide two distinct laser focussing distances, each distance being compatible with the particular format of each side of the disc.

Preferably, the first CD-readable side of the disc comprises a reflective CD-readable layer and the second DVD-readable side of the disc comprises a reflective DVD-layer, in accordance with conventional CD and DVD design. Preferably, the reflective CD- and DVD-layers are silvered. Further, the reflective CD-readable layer is preferably at a distance of about 1.2 mm from an outer surface of the CD-readable side of the disc. Similarly, the reflective DVD-readable layer is preferably at a distance of about 0.6 mm from an outer surface of the DVD-readable side of the disc, and a partially reflective DVD-readable layer is included, as is normal for a double sided DVD.

Preferably, the second DVD-readable side of the disc comprises at least one partially reflective DVD-readable layer. More preferably, the number of partially reflective DVD-readable layers is between 1 and 4, in accordance with conventional DVD disc design. More preferably, the number of partially reflective DVD-readable layers is 1 or 2.

Additionally, the double-sided disc of the present invention ideally comprises a substrate layer which defines an outer surface of the disc. The substrate layer may provide scratch-resistance and preferably protects the optically readable layers from damage in normal use. Substrate layers for CDs and DVDs are well known in the art.

Preferably, a double-sided disc according to the present invention has a total thickness of about 1.8 mm. More preferably, the first CD-readable side of the disc has a thickness of about 1.2 mm and the second DVD-readable side of the disc has a thickness of about 0.6 mm. The DVD-readable side of the disc may be manufactured using existing technologies. The CD-readable side of the disc may be manufactured in a conventional manner.

Preferably, a double-sided disc according to the present invention has a diameter of about 12 cm. This is the size of standard CDs and DVDs. However, the present invention would work equally well in other sizes of CDs and DVDs, for example, ‘mini-discs’.

The double-sided disc of the present invention may be produced by bonding the two sides of the disc together using conventional bonding methods, such as u.v. or hot-melt bonding. The central non-readable part of the disc may then be finished for accommodating the removable hub. The finishing may involve, for example, drilling additional holes in the central non-readable part of the disc which are shaped to receive friction-fitting projections on the removable hub.

The present invention further provides a combination of a double-sided disc as hereinbefore described and a removable hub having a central opening. The opening is for mounting the disc onto a spindle when in use.

In one embodiment of the present invention, the hub is positioned in a DVD mode. In this embodiment, the hub is preferably positioned so that a surface of the hub lies flush with an outer surface of the disc. It will be understood that in order for a surface of the hub to lie flush with an outer surface of the disc, the central non-readable part of the disc should be recessed to accommodate the hub. Hence, the outer surface (or face) of the DVD-readable side of the disc and a surface of the hub cooperatively form a substantially flat surface when in the DVD mode.

In another arrangement, the hub may be positioned in a CD mode. In this embodiment, the hub is once again preferably positioned so that the surface of the hub lies flush with the first CD-readable side (or face) of the disc. Thus, in the CD mode, the hub acts as a spacer between the laser and the CD-readable layer of the disc.

Preferably, one surface of the hub has a raised annulus about the central opening. Thus, the raised annulus defines partially the central opening of the hub. Preferably, the hub has a thickness of about 1.2 mm, as measured at the raised annulus.

Preferably, the hub is secured to the disc by a friction-fitting means. Such means will be well-known to the skilled person. For example, the friction-fitting means may comprise at least two spit-pins on the hub which engage with corresponding recesses or openings on the disc. Alternatively, the hub may be secured to the disc by a suitable clip mechanism or a counter-rotational screw fitting.

In another aspect of the present invention, there is provided a hub as described hereinabove.

Specific embodiments of the present invention are now described, by way of example only, with referenced to the accompanying drawings in which:

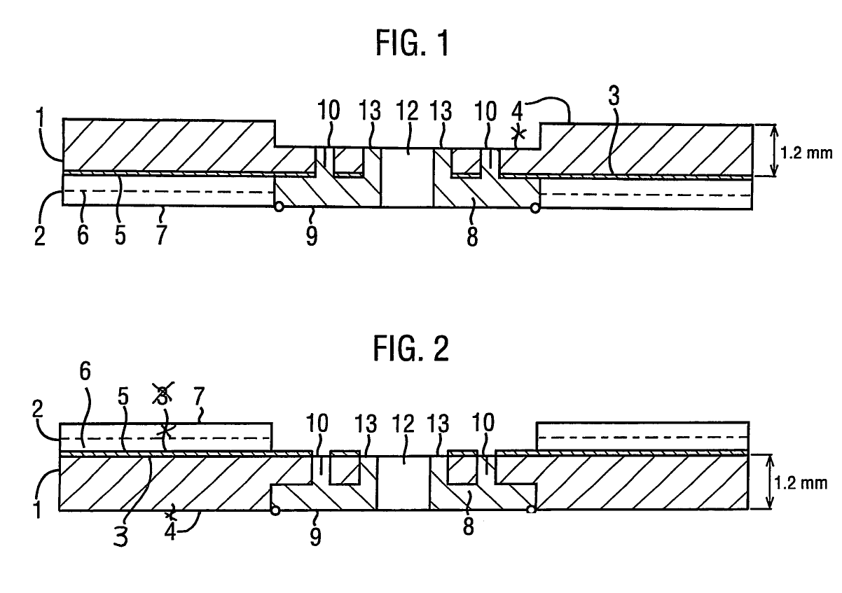

FIG. 1 shows a side view of a combination of a disc and hub according to the present invention in a DVD mode.

FIG. 2 shows a side view of a combination of a disc and hub according to the present invention in a CD mode.

FIG. 3 shows a plan view of a hub as used in the present invention.

Referring to FIGS. 1 and 2, a double-sided disc comprises a CD-readable side (1) and a DVD-readable side (2). The CD-readable side comprises a reflective CD-readable layer (3) and a CD outer surface (4). The DVD-readable side comprises a reflective DVD-readable layer (5), a partially reflective DVD-readable layer (6) and a DVD outer surface (7).

Referring to FIG. 1, a disc in a DVD mode is shown. Specifically, a hub (8) is positioned having a hub surface (9) which lies flush with the DVD outer surface (7) of the disc. The hub is secured to the disc by means of two split-pins (10), which engage with corresponding openings in the disc. The engagement prevents the disc from rotating relative to the hub. When in use, the hub rests on a spindle (not shown) via its central opening (12). The central opening (12) is partly defined by a raised annulus (13) of the hub. It will be seen that the distance between a laser (not shown) and the DVD-readable layer (5) is determined by the positioning of the hub relative to the disc.

Referring to FIG. 2, the disc is shown in a CD mode. Specifically, the hub (8) is positioned such that it lies flush with the CD-readable side (2) of the disc with the raised annulus (13) of the hub engaging the disc. The hub is secured to the disc by means of the two split-pins (10), which engage with the openings in the disc. It will be seen that the distance between a laser (not shown) and the CD-readable layer (3) is determined by the positioning of the hub relative to the disc. More particularly, the relative distance between the laser (not shown) and the CD-readable layer (3) is about 1.2 mm when the hub is positioned in a CD mode and the hub rests on a spindle (not shown).

The hub is removable so that the double-sided disc may be used in either a DVD mode (FIG. 1) or a CD mode (FIG. 2).

Referring to FIG. 3, a hub (1) is shown which is detached from the double-sided disc of the present invention. The hub comprises a central opening (12), a raised annulus (13) and two split-pins (10).

It will, of course, be understood that the present invention has been described by way of example only and that modifications of detail can be made within the scope of the invention.

1. A double-sided disc suitable for use in two different types of optical readers, said disc comprising a first side which is readable by a first type of optical reader and a second side which is readable by a second type of optical reader.

2. A double-sided disc as claimed in claim 1 suitable for use in a CD player and a DVD player, said disc comprising a first CD-readable side and a second DVD-readable side.

3. A double-sided disc as claimed in claim 2 wherein said disc is adapted to receive a removable hub which can be positioned to provide either a CD mode or a DVD mode.

4. A double-sided disc as claimed in claim 2 wherein the first CD-readable side comprises a reflective CD-readable layer and the second DVD-readable side comprises a reflective DVD-readable layer.

5. A double-sided disc as claimed in claim 4 wherein the reflective CD- and DVD-readable layers are silvered layers.

6. A double-sided disc as claimed in claim 4 wherein the second DVD-readable side further comprises at least one partially reflective DVD-readable layer.

7. A double-sided disc as claimed in claim 1 wherein each side of the disc comprises a substrate layer which defines a respective first type and second type outer surface of the disc.

8. A double-sided disc as claimed in claim 7 wherein the disc has a total thickness of over 1.8 mm.

9. A double-sided disc as claimed in claim 7 wherein the disc has a diameter of about 12 cm.

10. A double-sided disc as claimed in claim 2 wherein the first CD-readable side has a thickness of about 1.2 mm and the second DVD-readable side has a thickness of about 0.6 mm.

11. A combination of a double-sided disc suitable for use in two different types of optical readers, said disc comprising a first side having a first type outer surface and a second side having a second type outer surface, and a removable hub having a central opening, and further, a recess in said disc is provided for accommodating the hub.

12. A combination as claimed in claim 11 wherein the hub is positioned in a DVD mode.

13. A combination as claimed in claim 11 wherein the hub is positioned in a CD mode.

14. A combination as claimed in claim 13 wherein the hub is positioned so that a surface of the hub lies flush with said first type outer surface of the disc.

15. A combination as claimed in claim 11 wherein the hub has a raised annulus about its central opening.

16. A combination as claimed in claim 15 wherein the hub has a thickness of about 1.2 mm.

17. A combination as claimed in claim 11 wherein the hub is secured to the disc by a friction-fitting means.

18. A combination as claimed in claim 17 wherein the friction-fitting means comprises at least two split-pins on the hub which engage with corresponding recesses or openings on the disc.

19. A hub adapted to be removably received in a double-sided disc suitable for use in two different types of optical readers, said disc comprising a first side and a second side; wherein the hub can be positioned to provide either a first type optical reader mode or a second type optical reader mode.

20. A hub as claimed in claim 19 wherein said hub in said first type mode comprises positioning so that a surface of the hub lies flush with a first type outer surface of said first side and said hub in said second type mode comprises positioning so that said surface of the hub lies flush with a second type surface of said second side.

21. (Cancel)
